(19) United States
(12) Patent Application Publication
(10) Pub. No.: US 2023/0181949 A1
(43) Pub. Date: Jun. 15, 2023

(54) BULKHEAD ARRANGEMENT FOR FLOODING A SPACE

(71) Applicant: AUDI AG, Ingolstadt (DE)

(72) Inventors: Marc-Alexander NEUHAUSEN, Neufahrn (DE); Markus THURMEIER, Adlkofen (DE)

(21) Appl. No.: 18/065,499

(22) Filed: Dec. 13, 2022

(30) Foreign Application Priority Data
Dec. 14, 2021 (DE) 102021133101.3

(51) Int. Cl. A62C 3/16; A62C 3/07

(52) U.S. Cl. CPC A62C 3/16; A62C 3/07

(57) ABSTRACT

A bulkhead arrangement for flooding a space comprises at least one bulkhead element, which has sealing elements at side boundary surfaces and one boundary surface toward the floor and which can be connected at side connection sites to an infrastructure and/or another bulkhead element for sealing off the space and then flooding the space with an extinguishing agent, wherein the bulkhead element comprises a variably adjustable outflow opening in the direction of the height of the bulkhead element.

### BACKGROUND

### Technical Field

Embodiments of the invention relate to a bulkhead arrangement for flooding a space, such as a traction battery of a vehicle which is located in the space.

### Description of the Related Art

In event of a fire in a traction battery or vehicle battery of an electric vehicle, a lot of extinguishing agent is often needed to quench the vehicle, since the extinguishing agent cannot be sprayed directly onto the burning traction battery. The battery box of electric vehicles is well sealed, so that in event of a fire only slight amounts of extinguishing agent can get into the traction battery. Especially critical are situations in which a burning electric vehicle is parked in a garage. The poor access to the vehicle makes the fire extinguishing more difficult. Furthermore, the flames may cause great damage to the vehicle and to a building.

### BRIEF SUMMARY

Some embodiments provide an efficient possibility of extinguishing a fire of a traction battery.

Some embodiments include forming a kind of water-tight tub around the electric vehicle in order to extinguish a burning traction, which can be filled with an extinguishing agent, such as water. Thus, the vehicle battery is flooded with extinguishing agent, which effectively puts out the fire. In order to form the water-tight tub, one or more bulkhead elements can be arranged around the vehicle, and the space formed by the bulkhead elements can be flooded with extinguishing agent.

Some embodiments provide a bulkhead arrangement for flooding a space, comprising at least one bulkhead element, which has sealing elements at side boundary surfaces and one boundary surface toward the floor and which can be connected at side connection sites to an infrastructure and/or another bulkhead element for sealing off the space and then flooding the space with an extinguishing agent, wherein the bulkhead element comprises a variably adjustable outflow opening in the direction of the height of the bulkhead element.

In other words, at least one bulkhead element can be provided, i.e., a wall, which is adapted to hold back a liquid, such as water. This bulkhead element can have sealing elements at least on side boundary surfaces and a boundary surface with the floor, so that the bulkhead element at these sites is essentially sealed off, for example, by rubber seals. The sealing elements on the side boundary surfaces can be arranged on an infrastructure, so that they seal off the space together with the infrastructure. The bulkhead element can be fastened via connection sites to the infrastructure and/or another bulkhead element in order to form the space in which the motor vehicle with the traction battery is located, and the space so sealed off can then be flooded with an extinguishing agent. The extinguishing agent used can be a liquid or gel-formed extinguishing agent, such as water or aerogels.

The infrastructure to which the bulkhead element can be connected can be for example a garage, such as a garage opening in which the bulkhead element can be hung, so that the interior of the garage forms the space which can be flooded with the extinguishing agent. Alternatively, multiple bulkhead elements may be joined together, such as at least four, so that an at least rectangular space is produced, which can then be flooded with extinguishing agent.

The bulkhead element can be portable and arranged suitably in event of a fire of the traction battery in order to seal off the space in which the motor vehicle with the traction battery is located. The height of the bulkhead element can be dictated for example such that the extinguishing agent reaches at least the traction battery when the space is filled with the extinguishing agent, the bulkhead element being taller, and the extinguishing agent height is established by a variably adjustable outflow opening. For example, the height of the bulkhead element can be between 60 cm and 1.20 m, such as 1 m.

So that only the traction battery is extinguished and no damage occurs to other components of the motor vehicle due to the extinguishing agent, it is furthermore provided that the bulkhead element has an outflow opening which is adapted to limiting the extinguishing agent height in the space to a predetermined height, the height at which the outflow opening can be set being dictated by the height of the traction battery in the motor vehicle. The advantage of this variably adjustable outflow opening is that the bulkhead element can be suitably adjusted to different vehicle types, since the traction battery in different vehicle types may be located at different heights. Thus, thanks to the outflow opening, only the traction battery will be flooded by the extinguishing agent and not any other vehicle components, such as the vehicle interior.

Some embodiments provide the advantage that a sealed-off space can be created for the flooding with extinguishing agent, by which a fire of a traction battery can be efficiently put out, since the extinguishing agent gets directly to the traction battery, and thanks to the variably adjustable outflow opening other vehicle components can be protected, since the extinguishing agent only reaches to the height of the traction battery thanks to suitable adjustment of the outflow opening.

One embodiment provides that the outflow opening is arranged in a sliding element, which can be displaced in the height direction of the bulkhead element. In other words, the outflow opening can be a hole in a sliding element, which can be displaced upward and downward in the direction of the height of the bulkhead element. Markings can also be provided on the sliding element as to which extinguishing agent height can be reached in which position of the sliding element and/or for which vehicle type a suitable position of the sliding element is provided for the flooding of the traction battery. This embodiment affords the advantage that an implementation of the outflow opening can be provided.

A further embodiment provides that the bulkhead element comprises an extinguishing agent port, by which the extinguishing agent can be brought in to flood the space. The extinguishing agent port can be configured for example for a garden hose and/or a fire-fighting hose, by which the extinguishing agent can be admitted into the space. This embodiment affords the advantage that a flooding of the space is more easily possible.

A further embodiment provides that the at least one bulkhead element is formed from a heat-resistant material and/or a heat-resistant coating. In other words, the at least one bulkhead element can be formed from a heat-resistant material, such as a metal and/or a ceramic, such as aluminum. Alternatively or additionally, the bulkhead element can have a heat-resistant coating. For example, the bulkhead element can be formed from a plastic, on which a coating of ceramic and/or an aerogel is formed at least in the direction of the space. This embodiment affords the advantage that the bulkhead element is not damaged in event of a fire of the traction battery, so that a better sealing off of the space can be achieved.

A further embodiment provides that the at least one bulkhead element is formed from a light construction material, such as plastic and/or aluminum. By a light construction material is meant that the total weight of the bulkhead element remains below a predetermined weight value, so that the bulkhead element can be transported by one or two persons and set up to seal off the space. In particular, the predetermined weight value for a bulkhead element can be under 20 kg, such as under 10 kg, thanks to the formation by means of light construction material. This embodiment affords the advantage that the bulkhead element can be better transported and set up.

In a further embodiment it is provided that the at least one bulkhead element comprises hollow chambers. In other words, a wall of the bulkhead element can have hollow chambers, through which the weight of the bulkhead element can be further reduced. This embodiment affords the advantage that the bulkhead element has a lower weight and can thereby be better transported and set up to seal off the space.

It may be provided that the hollow chambers are designed to fill with the extinguishing agent when the space is flooded. Thus, for example, a respective hollow chamber can have openings in the direction of the space being flooded, through which the extinguishing agent gets into the hollow chambers. This affords the advantage that the bulkhead element is cooled and thus the bulkhead element is protected against heat in event of a fire of the traction battery. A further benefit of this is that the weight of the extinguishing agent presses in the hollow chambers in the direction of the floor and the sealing element situated there, so that the bulkhead element can seal off the space even better.

A further embodiment provides that the sealing elements are plug-in seals and/or at least the sealing element on the boundary surface with the floor is configured as a self-adhesive seal. In other words, the sealing elements can be placed on the bulkhead element and/or on an infrastructure/floor. Alternatively or additionally, at least the sealing element which is situated at the boundary surface with the floor can be designed as a self-adhesive seal, so that this sealing element sticks fast after the bulkhead element is arranged on the floor, achieving a better sealing effect. The sealing elements used can be rubber seals, for example, which are particularly adapted to withstand high temperatures.

A further embodiment provides that multiple bulkhead elements are connected via the side connection sites to produce an at least rectangular arrangement forming the space. In other words, at least four bulkhead elements are connected via the side connection sites, for example being inserted, so that a substantially rectangular space is formed. The space can have the dimensions of a motor vehicle. This embodiment affords the advantage that a space which can be flooded with extinguishing agent can even be formed at outdoor parking areas or an area in an underground garage. The rectangular arrangement of the bulkhead elements can be quickly achieved, for example in event of a fire of the traction battery, by connecting the individual bulkhead elements around the motor vehicle, or by having the bulkhead elements already connected to form the at least rectangular arrangement, and these can be overturned onto the motor vehicle in order to create the space.

It may be provided that the respective side connection sites of the bulkhead elements are connected by a respective sealing band, having the same height as the bulkhead elements, and the bulkhead elements are hinged by the sealing band on the side connection sites. The sealing band can have a sealing element in the direction of the floor or be inserted into a sealing element, so that a sealing can also be accomplished there. The sealing band affords the advantage that the rectangular arrangement is sealed off at the corners, so that no extinguishing agent can escape, and the bulkhead arrangement can be hinged together from multiple bulkhead elements and be more easily adapted to the given circumstances. In particular, the individual bulkhead elements when not in use can also be folded on top of one another in order to achieve a smaller packing size.

Some embodiments include combinations of the features of the described embodiments. Thus, some embodiments include realizations having a combination of the features of several of the described embodiments, as long as the embodiments are not described as being mutually exclusive.

### BRIEF DESCRIPTION OF THE SEVERAL VIEWS OF THE DRAWINGS

FIG. 1 shows a bulkhead arrangement according to one embodiment.

FIG. 2 shows a side connection site of a bulkhead element with an infrastructure.

FIG. 3 shows a bulkhead arrangement according to another embodiment.

FIG. 4 shows cross sections of bulkhead elements according to embodiments.

FIG. 5 shows a side connection site between two bulkhead elements.

### DETAILED DESCRIPTION

In the embodiments described herein, the components described for the embodiments each time constitute individual features, to be viewed independently of each other, and which also further develop embodiments independently of each other. Therefore, the disclosure will also encompass other than the represented combinations of features of the embodiments. Moreover, the described embodiments can also be supplemented with other of the already described features.

In the figures, the same reference numbers each time denote identical function elements.

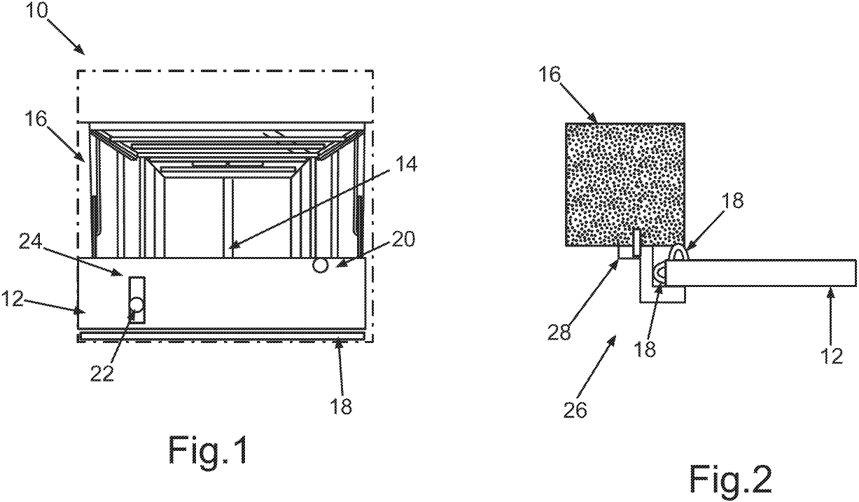

In FIG. 1 a bulkhead arrangement 10 according to one embodiment is shown. The bulkhead arrangement 10 in this embodiment can comprise at least one bulkhead element 12, which is adapted to retain an extinguishing agent, such as water, and thus to hold it inside a space 14.

This may be advantageous if a motor vehicle having a traction battery is parked in the space 14 and the traction battery needs to be cooled or extinguished. In this case, a water-tight tub can be formed by means of the bulkhead element 12, which can be flooded with the extinguishing agent in order to reach the traction battery directly, which would be hard to accomplish with traditional extinguishing methods from the outside.

In this case, the bulkhead element can be connected at side connection sites (not shown in this figure) to an infrastructure 16, such as to walls of a garage. For example, the bulkhead element can be arranged in front of a garage door in order to create, together with the walls of the garage, the space 14 which can be flooded with the extinguishing agent.

The bulkhead element 12 comprises sealing elements 18 at side boundary surfaces and a boundary surface with the floor, and the sealing elements 18 can be plug-in seals which can thus be connected to the bulkhead element 12 and/or the infrastructure 16. Alternatively or additionally, the sealing elements 18 can be designed as self-adhesive seals, which can be affixed to the floor and/or the walls of the garage in order to seal off the space 14.

In order to position the bulkhead element 12 quickly in front of the garage door in event of a fire of the traction battery, it may be provided that the bulkhead element is made of a light construction material, such as a plastic and/or aluminum. Furthermore, the bulkhead element 12 can have hollow chambers, by which the weight of the bulkhead element 12 can be further reduced. Furthermore, it may be provided that the bulkhead element 12 is formed from a heat-resistant material and/or has a heat-resistant coating, such as a ceramic and/or an aerogel. Thus, the bulkhead element can withstand the heat of a fire, at least for a short time.

In order to flood the space 14 sealed off by the bulkhead element 12, an extinguishing agent port 20 can be arranged on one side wall of the bulkhead element 12, where an extinguishing agent hose can be attached and by which the extinguishing agent can then be brought into the space 14. The extinguishing agent port 20 can have a thread or a plug connection, by which the extinguishing agent hose can be attached.

In order to prevent other components of the motor vehicle from being damaged during the flooding of the space 14 and to prevent the extinguishing agent from getting into the interior of the motor vehicle, for example, a variably adjustable outflow opening 22 can additionally be provided in the bulkhead element 12, through which the extinguishing agent can flow away upon reaching a predetermined extinguishing agent height. The outflow opening 22 can be a hole in the bulkhead element 12, which is situated in a sliding element 24, and when the sliding element 24 is moved the outflow opening 22 can be displaced in the height direction of the bulkhead element 12. Thus, the outflow opening 22 can be appropriately adjusted for different vehicle types, so that a traction battery of one vehicle type is reached by the extinguishing agent, yet no other vehicle components are flooded by the extinguishing agent.

FIG. 2 shows a side connection site 26 of the bulkhead element 12 with the infrastructure 16 according to one embodiment, the connection site 26 of the bulkhead element 12 being represented here with the left side of the garage 16 from above, as an example. For the attachment of the bulkhead element 12 to the garage 16, an angle iron 28 can be screwed to a wall of the garage 16, so that the bulkhead element 12 can be inserted downward from the top into the angle iron 28. A corresponding connection site 26 can also be present on the right side of the garage 16.

Moreover, the bulkhead element 12 can have the sealing elements 18 on the side boundary surfaces, while the sealing elements 18 may either be present in both positions represented or only at one of these positions. That is, the sealing elements 18 can be arranged either on only one narrow side of the bulkhead element 12 or on a side surface in the direction of a side boundary surface of the bulkhead element 12.

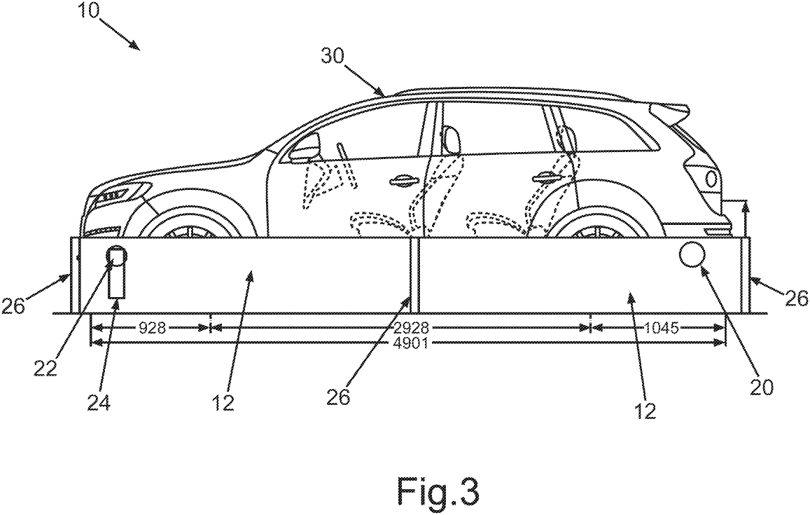

FIG. 3 shows a bulkhead arrangement 10 according to another embodiment. In this embodiment, multiple bulkhead elements 12 can be connected at the respective side connection sites 26 to form a rectangular arrangement, and the connected bulkhead elements 12 can be arranged to run around the motor vehicle 30. At least one of the bulkhead elements here can be configured as in the previously described embodiment. One of the bulkhead elements 12 can also have the extinguishing agent port 20, for example, and another one can have the outflow opening 22 which is adjustable by the sliding element 24.

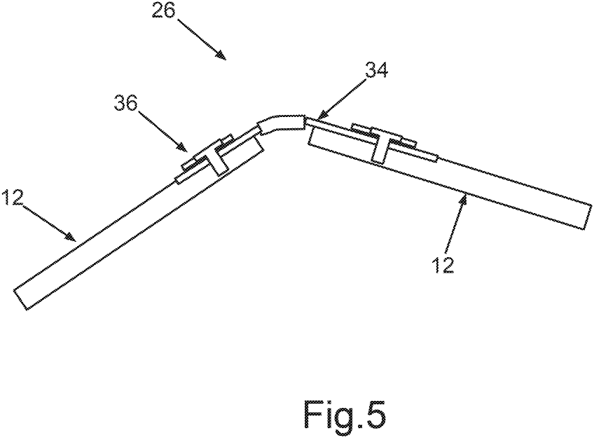

The respective bulkhead elements 12 can for example be inserted into one another at the connection sites 26 and/or they can be connected with respective sealing bands 34, which are explained more closely in FIG. 5. In event of a fire of the traction battery of the motor vehicle 30, the bulkhead arrangement 10 shown here can be built up around the motor vehicle 30 or it can be overturned as a whole over the motor vehicle 30, before the space 14 formed inside the bulkhead elements 12 is flooded with the extinguishing agent in order to cool or extinguish the traction battery.

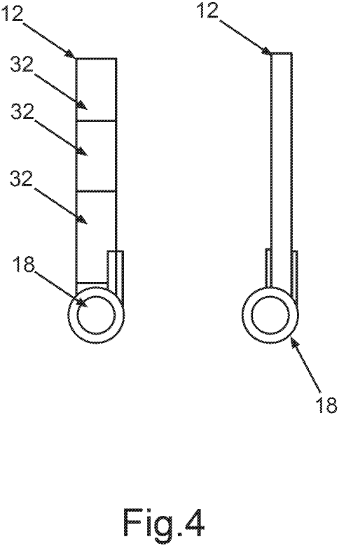

FIG. 4 shows two cross sections of bulkhead elements 12, the bulkhead element 12 represented at the left being configured with multiple hollow chambers 32, which can reduce the weight of the bulkhead element 12. The hollow chambers 32 are designed to also fill up with the extinguishing agent upon flooding of the space 14, so that the weight is increased downward in the direction of the floor, further increasing the sealing effect of the sealing element 18. The sealing element 18 can for example be applied by means of a plug connection at the corners of the sealing element 18, with the sealing element 18 running across the entire cross section of the bulkhead element 12. The advantage of this is that the stiffness can be increased and the bulkhead element 12 is more durable.

An alternative configuration for the bulkhead element 12 is shown in FIG. 4 at the right side, the bulkhead element 12 here being a flat sheet, for example around 15 mm thick, and may be made from a light construction material, such as aluminum. The sealing element 18 here can be applied to the entire bulkhead element 12, providing an easier connection possibility.

FIG. 5 shows a connection site 26 between two bulkhead elements 12. The two bulkhead elements 12 here can be connected by means of a sealing band 34, the sealing band 34 being highly flexible and tear-resistant. For example, the thickness of the sealing band 34 may be around 5 mm, so that the sealing band 34 can be coupled with a sealing element 18 on the floor. Furthermore, the sealing band 34 may have the same height as the bulkhead elements 12, so that an enclosed space can be created. For the fastening of the sealing band 34, this can be connected by fastening means 36 to the respective bulkhead element 12. The fastening means 36 used can be for example a molding strip and screws.

In another aspect it is provided that a water-tight tub (space 14) is formed by means of the bulkhead arrangement 10, one portion of the tub being formed by a heat-resistant coating, and the bulkhead elements 12 of the bulkhead arrangement 10 are placed at least partly on walls and/or a floor of a garage 16. An installable bulkhead element 12, for example at a garage entrance, can complete the substantially water-tight tub.

In event of a fire, the tub can be filled with water from a garden hose or by the fire department, until the traction battery is flooded. The tub height can be adjusted according to the vehicle, so that it is suitable for both low vehicles and SUVs. The water after the extinguishing process can be pumped out and disposed of, such as in an environmentally proper manner.

On the whole, the examples show a battery extinguishing method for electric automobiles, such as in garages.

German patent application no. 10 2021 133101.3, filed Dec. 14, 2021, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A bulkhead arrangement for flooding a space, comprising:
at least one bulkhead element, which has sealing elements at side boundary surfaces and one boundary surface toward a floor and which can be connected at side connection sites to an infrastructure and/or another bulkhead element for sealing off the space and then flooding the space with an extinguishing agent,
wherein the bulkhead element comprises a variably adjustable outflow opening in the direction of the height of the bulkhead element.

2. The bulkhead arrangement according to claim 1, wherein the outflow opening is arranged in a sliding element, which can be displaced in the height direction of the bulkhead element.

3. The bulkhead arrangement according to claim 1, wherein the bulkhead element comprises an extinguishing agent port, by which the extinguishing agent can be brought in to flood the space.

4. The bulkhead arrangement according to claim 1, wherein the at least one bulkhead element is formed from a heat-resistant material and/or a heat-resistant coating.

5. The bulkhead arrangement according to claim 1, wherein the at least one bulkhead element is formed from a light construction material.

6. The bulkhead arrangement according to claim 5, wherein the light construction material is plastic and/or aluminum.

7. The bulkhead arrangement according to claim 1, wherein the at least one bulkhead element comprises hollow chambers.

8. The bulkhead arrangement according to claim 7, wherein the hollow chambers are designed to fill with the extinguishing agent when the space is flooded.

9. The bulkhead arrangement according to claim 1, wherein the sealing elements are plug-in seals and/or at least the sealing element on the boundary surface with the floor is configured as a self-adhesive seal.

10. The bulkhead arrangement according to claim 1, wherein multiple bulkhead elements are connected via the side connection sites to produce an at least rectangular arrangement forming the space.

11. The bulkhead arrangement according to claim 10, wherein the respective side connection sites of the bulkhead elements are connected by a respective sealing band, having the same height as the bulkhead elements, and the bulkhead elements are hinged by the sealing band on the side connection sites.
